(19) United States
(12) Patent Application Publication
(10) Pub. No.: US 2015/0062445 A1
(43) Pub. Date: Mar. 5, 2015

(54) SIMULATION SYSTEM FOR SIMULATING MULTI-PROJECTION SYSTEM

(71) Applicant: CJ CGV CO., LTD., Seoul (KR)

(72) Inventors: Hwan Chul KIM, Seoul (KR); Su Ryeon KANG, Goyang-si (KR)

(73) Assignee: CJ CGV CO., LTD., Seoul (KR)

(21) Appl. No.: 14/218,297

(22) Filed: Mar. 18, 2014

(30) Foreign Application Priority Data
Sep. 3, 2013 (KR) 10-2013-0105279

(51) Int. Cl. H04N 5/74

(52) U.S. Cl. CPC H04N 5/74
USPC 348/744

(57) ABSTRACT

The present invention provides a simulation system for simulating a multi-projection system, the simulation system including a plurality of projection surfaces, each having a transformable structure, thus selectively implementing internal structures of various multi-projection theaters.

### TECHNICAL FIELD

The present invention relates to a simulation system for simulating a multi-projection system and, more particularly, to a simulation system which can selectively implement internal structures (e.g., various multi-projection environments) of various multi-projection theaters.

### BACKGROUND ART

Conventionally, in order to reproduce images such as movies, advertisements, etc., two-dimensional images are projected on a single screen arranged in front of a theater. However, audiences can only watch two-dimensional (2D) images under such a system.

Three-dimensional (3D) image technologies for providing the audience with 3D images have recently been developed. 3D image technologies use the principle of allowing an audience to feel the 3D effect even from a flat image when different images are presented to the left and right eyes of the audience and combined in the brain. In detail, two cameras equipped with different polarizing filters are used during filming, and the audience wears glasses with polarizing filters such that different images are presented to the left and right eyes during watching.

However, while these 3D technologies can provide the audience with 3D images, the audience just watches the images reproduced on a single screen, which may reduce the degree of involvement in the images. Moreover, the direction of the 3D effect that the audience feels is limited to the direction of the single screen.

Furthermore, according to the conventional 3D technologies, the audience must wear the glasses equipped with polarizing filters during watching, which may make the audience feel inconvenient, and different images are artificially presented to the left and right eyes, which may make some sensitive audiences feel dizzy or nausea.

Therefore, a so-called “multi-projection system” which can solve the problems of the conventional projection systems based on a single screen has been proposed. The “multi-projection system” refers to a technology in which a plurality of projection surfaces are arranged around auditorium such that synchronized and unified images are reproduced on the plurality of projection surfaces, thus providing the audience with the three-dimensional effect and immersion.

Meanwhile, in order to efficiently operate the “multi-projection system”, it is necessary to simulate the operation of the “multi-projection system” in advance and to check the state where an image is reproduced in the “multi-projection system” in advance. However, there was no simulation technology related to the “multi-projection system” in the past.

In particular, the “multi-projection system” may have various structures (e.g., various numbers of projection surfaces, various surface materials of projection surfaces, various arrangements of projection surfaces, etc.) depending on the environment of a theater in which the system is constructed, but there was no simulation technology that can implement the various structures of the “multi-projection system”.

Therefore, there is a need to develop a technology that can meet these technical requirements.

### DISCLOSURE OF INVENTION

### Technical Problem

An object of the present invention is to provide a simulation system which can selectively implement internal structures (e.g., various multi-projection environments) of various multi-projection theaters with respect to a so-called “multi-projection system”.

### Solution to Problem

To achieve the above object, a simulation system in accordance with an embodiment of the present invention may comprise a plurality of projection surfaces, each having a transformable structure, and the simulation system selectively may implement internal structures of various multi-projection theaters.

The simulation system may further comprise a driving device for changing the structure of the projection surface, and the driving device may change the size or arrangement of the projection surface.

The projection surface may be configured to move by means of a rail structure.

The driving device may be configured to adjust the arrangement angle of the projection surface by means of a joint structure.

The simulation system may further comprise a surface replacement device which changes the surface material of the projection surface by replacing a surface sheet for covering the surface of the projection surface.

The surface sheet of the projection surface may be changed by means of a roll structure or a blind structure.

The surface of the projection surface may be configured to be attached and detached and the material of the projection surface may be changed by the attachment and detachment of the surface.

The simulation system may further comprise a projection device for projecting synchronized images on the plurality of projection surfaces.

The projection device may be two or more in number and the two or more projection devices may be configured to move horizontally or vertically.

The projection device may be configured to move horizontally by means of a rail structure and move vertically by a change in length of a connection shaft.

The projection angle of the projection device may be configured to be adjusted.

The projection angle of the projection device may be adjusted by movement of a lens installed in the projection device.

The projection angle of the projection device may be adjusted by means of a joint structure of the connection shaft.

The projection device may project a corrected image, and the correction of the image may be performed based on surface information of the plurality of projection surfaces after being transformed.

The correction of the image may be performed so as to offset a difference in brightness, a difference in color, or a difference in reflectance between the transformed projection surfaces.

The simulation system may further comprise an additional effect device for implementing an additional effect other than the image.

The additional effect device may be configured to move horizontally or vertically.

The additional effect device may be configured to move horizontally by means of a rail structure and move vertically by a change in length of a connection shaft.

The additional effect device may be arranged on the surface of the projection surface.

### Advantageous Effects of Invention

The present invention can provide a simulation environment which can selectively implement various internal structures (e.g., various multi-projection environments) of a multi-projection system.

Therefore, it is possible to perform the simulation of various multi-projection theaters, which may be configured in different structures (e.g., different numbers of projection surfaces, different arrangements of projection surfaces, different materials of projection surfaces, different arrangements of projection devices, etc.), in on space.

### BRIEF DESCRIPTION OF DRAWINGS

FIGS. 1 to 3 are diagrams showing examples of a multi-projection system.

FIG. 4 is a diagram showing the configuration of a simulation system in accordance with an embodiment of the present invention.

FIG. 5 is a diagram showing an example in which the arrangement angle of a projection surface is changed.

FIG. 6 is a diagram showing an example in which the size of a projection surface is changed.

FIG. 7 is a diagram showing an example in which a simulation system in accordance with an embodiment of the present invention implements the internal structure of a specific multi-projection theater.

FIG. 8 is a diagram showing an example of a projection surface having a detachable surface structure.

FIG. 9 is a diagram showing an example in which the surface material of a projection surface is changed by means of a blind structure.

FIG. 10 is a diagram showing an example in which the surface material of a projection surface is changed by means of a roll structure.

FIG. 11 is a diagram showing an example of a projection device configured to move.

### MODE FOR THE INVENTION

Hereinafter, a simulation system according to the present invention will be described in detail with reference to the accompanying drawings. The following embodiments are provided only for illustrative purposes so that those skilled in the art can fully understand the spirit of the present invention, but the present invention is not limited thereby. Moreover, it is to be understood that all matters herein set forth in the accompanying drawings are to be interpreted as illustrative and may be in different forms from those actually implemented.

The simulation system according to the present invention, which will be described below, is an invention for simulating a so-called “multi-projection system” so as to selectively simulate internal structures (e.g., various multi-projection environments) of various multi-projection theaters.

Therefore, the “multi-projection system” that is the basis of the present invention will now be described briefly, and then the features of the present invention will be described in detail later.

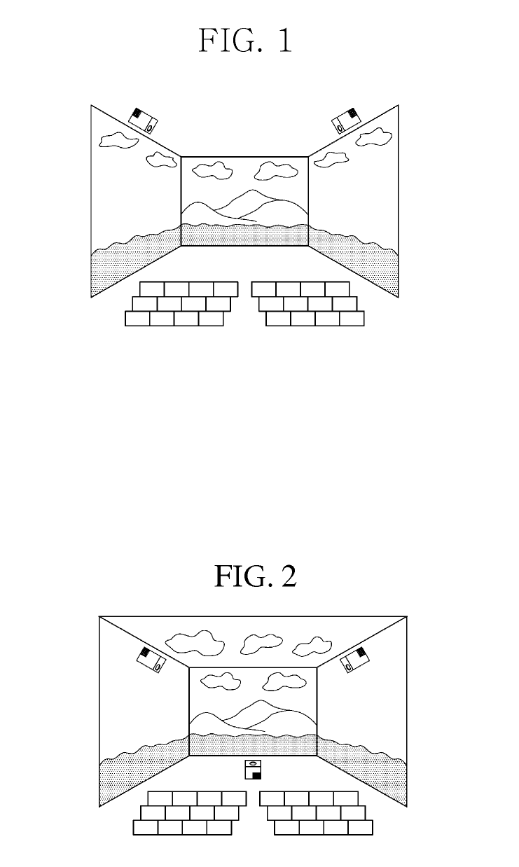

Next, the multi-projection system that is the basis of the present invention will be described with reference to FIGS. 1 to 3.

The multi-projection system that is the basis of the present invention refers to a system which can provide synchronized images on a plurality of projection surfaces installed in a single theater and maximize the reality, three-dimensional effect, and immersion that the audience can feel in these environments. That is, the multi-projection system refers to a system in which a plurality of projection surfaces are provided in a single theater to provide the audience with synchronized images on the plurality of projection surfaces.

The plurality of projection surfaces are provided for multi-projection in a single theater. A plurality of images may be reproduced on the plurality of projection surfaces. Here, it is preferable that the images reproduced on the plurality of projection surfaces are synchronized with each other and generally create a unified image. That is, while different images may be reproduced on the respective projection surfaces, it is preferable that the different images are synchronized with each other to create a unified image when viewed over the entire projection surface. Of course, depending on the situations, an independent image may be reproduced on each projection surface or images may be reproduced only on some of the projection surfaces.

Meanwhile, the plurality of projection surfaces may reproduce images using all of the plurality of projection surfaces or using only some of the plurality of projection surfaces. For example, the plurality of projection surfaces may provide a state in which an image is reproduced only on a specific projection surface (state 1), a state in which images are reproduced only on some of the plurality of projection surfaces (state 2), and a state in which images are reproduced on all of the plurality of projection surfaces (state 3), and these states 1 to 3 may be implemented alternately during projection of image content.

Moreover, the plurality of projection surfaces may be arranged so as not to be parallel to each other. According to the prior art, an image is projected only on a screen placed in front of a theater such that the audience watches the image reproduced on the two-dimensional screen or a 3D technology is applied to the image itself reproduced on a plane. On the contrary, in the multi-projection system that is the basis of the present invention, the plurality of projection surfaces are three-dimensionally arranged so as not to be parallel to each other, and thus it is possible to provide the audience with a three-dimensional image with high three-dimensional effect and immersion through the three-dimensionally arranged plurality of projection surfaces without applying the 3D technology to the image itself.

Furthermore, it is preferable that the plurality of projection surfaces are arranged to surround the auditorium in the theater. Therefore, the audience can feel as if they are in a space created by the synchronized images reproduced on the plurality of projection surfaces, and thus the three-dimensional effect, immersion, and virtual reality that the audience feels can be maximized.

In addition, the angle between the projection surfaces is not limited to a specific angle, and the plurality of projection surfaces may be arranged at various angles as long as the audience can feel the three-dimensional effect.

Additionally, the plurality of projection surfaces may be arranged to be adjacent to each other or to be spaced from each other and, even in this case, it is preferable that the plurality of projection surfaces are arranged to surround the auditorium.

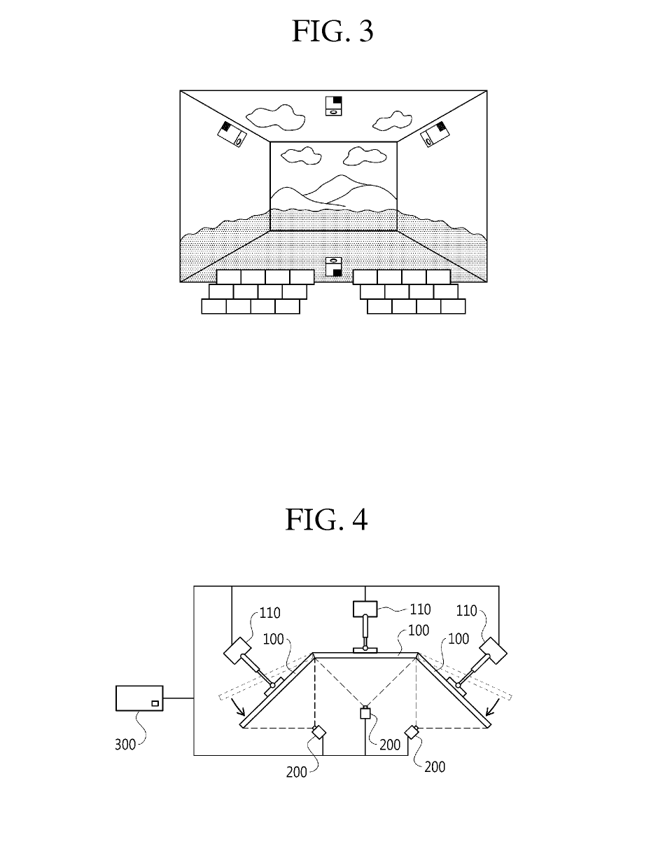

FIG. 1 shows an example in which the plurality of projection surfaces are arranged on the front, left, and right sides with respect to the audience seats, FIG. 2 shows an example in which the plurality of projection surfaces are arranged on the front, left, right, and top sides with respect to the audience seats, and FIG. 3 shows an example in which the plurality of projection surfaces are arranged on the front, left, right, top, and bottom sides with respect to the audience seats.

Moreover, the plurality of projection surfaces may comprise various types of projection surfaces such as a screen, wall, etc. and may comprise different types of projection surfaces at the same time.

Furthermore, the images projected on the plurality of projection surfaces may be projected by two or more projection devices installed in the theater, and these two or more projection devices may be implemented by including an optical system and a heating unit in various manners. For example, the projection devices may be implemented in various ways, such as by using a cathode ray tube (CRT), using a liquid crystal display (LCD), by digital light processing (DLP) using a digital micromirror device (DMD) chip, by liquid crystal on silicon (LCOS), etc. as well as various other ways. In addition, the two or more projection devices may be electrically connected to an image management device and then integratedly controlled by the image management device and may project images on the plurality of projection surfaces under the control of the image management device.

Meanwhile, the multi-projection system may further comprise an additional effect device for implementing an additional effect other than the images projected on the plurality of projection surfaces. Here, the additional effect device refers to a device that adds a visual effect or an effect that can be perceived by other senses than sight so as to increase the immersion and reality that the audience can feel while watching the images. The additional effects that can be provided by the additional effect device may include a sound effect, a wind effect, a smell effect, a fog effect, a temperature change effect, a laser effect, a light effect, a bubble effect, a water jet effect, a vibration effect, etc. as well as various effects associated with the five senses of human. Therefore, the additional effect device may comprise various devices such as a speaker, an air blower, a fragrance diffuser, a fog machine, a light-emitting device, a heater, a cooler, a laser device, a bubble generator, an LED, a water jet, a vibrator, etc. which can stimulate the five senses of human.

Next, a simulation system in accordance with an embodiment of the present invention will be described with reference to FIG. 4.

Referring to FIG. 4, the simulation system in accordance with an embodiment of the present invention may comprise a plurality of projection surfaces 100, each having a transformable structure, and a projection device 200 which projects synchronized images on the plurality of projection surfaces 100 and is configured to move.

Moreover, the simulation system may further comprise a simulation management device 300 for controlling and managing various devices included in the system.

As mentioned above, the multi-projection system may have various structures, and the simulation system in accordance with an embodiment of the present invention may selectively implement internal structures of various multi-projection theaters (e.g., multi-projection theater A already constructed, multi-projection theater B already constructed, multi-projection theater C to be constructed, etc.) by means of the plurality of projection surfaces 100 or the projection device 200.

The plurality of projection surfaces 100 may have a transformable structure to selectively implement the structures of various multi-projection theaters. Specifically, the plurality of projection surfaces 100 may have a structure in which the size, arrangement angle, arrangement position, etc. of each projection surface 100 can be transformed. This structural transformation of the plurality of projection surfaces 100 may be achieved by various electronic device or mechanical devices.

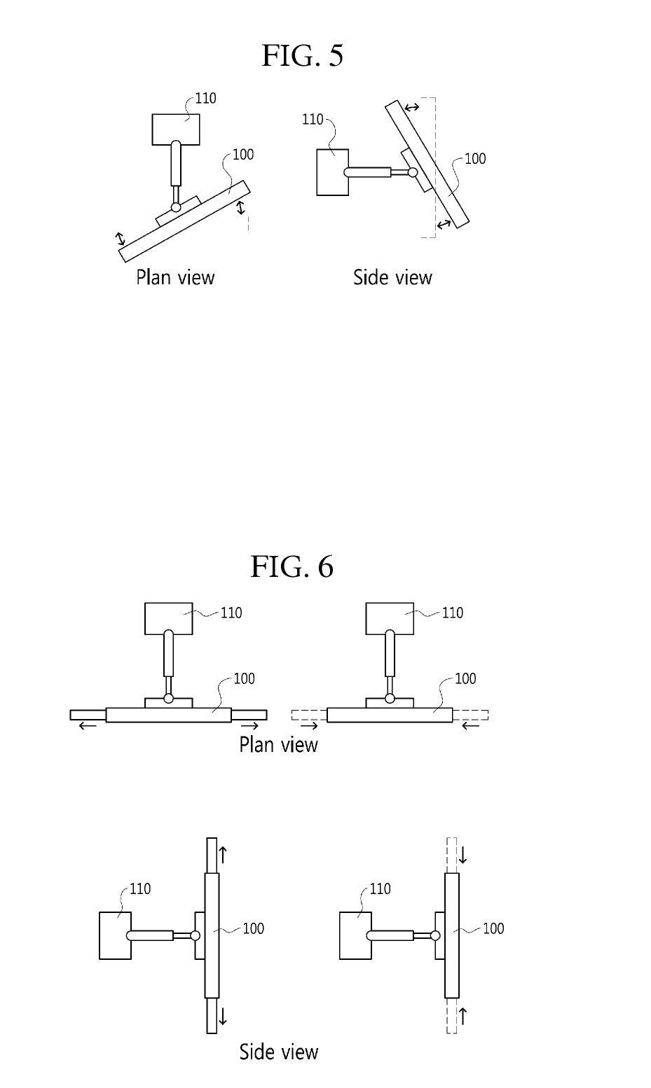

Referring to FIGS. 4 to 6, the plurality of projection surfaces 100 may be connected to a driving device 110, and the arrangement position, arrangement angle, size, etc. of each projection surface 100 may be changed by the control of the driving device 110. Specifically, the plurality of projection surfaces 100 may have a structure in which the arrangement angle, height, or direction of each projection surface 100 is three-dimensionally changed. For example, referring to FIG. 5, the plurality of projection surfaces 100 may have a structure in which the arrangement angle, height, or direction of each projection surface 100 may be changed by means of a joint structure controlled by the driving device 110. Moreover, the plurality of projection surfaces 100 may have a structure in which the arrangement position of each projection surface 100 can be individually changed. For example, the driving device 110 or the projection surface 100 may be installed on a rail structure such that the arrangement position of the projection surface 100 can be changed. Furthermore, the plurality of projection surfaces 100 may have a structure in which the size or area of each projection surface 100 can be changed. For example, referring to FIG. 6, the plurality of projection surfaces 100 may have a structure in which the size or area of each projection surface 100 can be changed by means of a multi-panel structure controlled by the driving device 110. Meanwhile, the driving device 110 may be of various types within the scope obvious to those skilled in the art and may preferably be implemented with various motors or actuators that provide mechanical movement based on power supplied from a power unit.

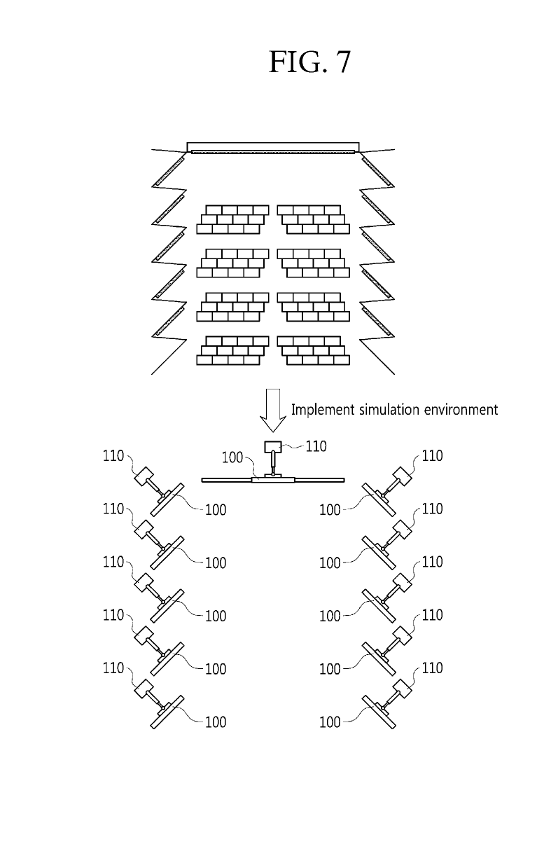

Referring to FIG. 7 showing an example in which the plurality of projection surfaces 100 selectively implement the internal structure of a specific multi-projection theater (e.g., multi-projection theater A), when the actual internal structure of a specific multi-projection theater (e.g., multi-projection theater A) is as shown in the top of FIG. 7, the driving device 110 may implement a simulation environment as shown in the bottom of FIG. 7 by transforming the structure of the plurality of projection surfaces 100. Specifically, the driving device 110 may change the position of each projection surface 100 by means of a rail structure to be the same as the specific multi-projection theater, may change the arrangement height or angle of each projection surface 100 by means of a joint structure to be the same as the specific multi-projection theater, and may change the size or area of each projection surface 100 by means of a multi-panel structure to be the same as the specific multi-projection theater. Meanwhile, the structural changes of the plurality of projection surfaces 100 by means of the driving device 110 are not limited to those described above, but may be implemented in various other ways.

Moreover, the plurality of projection surfaces 100 may be configured to selectively implement various surface materials (e.g., associated with color, shape, brightness, etc.). Specifically, the plurality of projection surfaces 100 may be configured to selectively implement various surface materials such as fabric, plaster, tectum, curtain, aluminum, PVC, etc. These various surface materials of the plurality of projection surfaces 100 may be implemented in various ways such as (1) by configuring the surface of each projection surface 100 with a detachable structure, (2) by selectively replacing a surface sheet for covering the surface of each projection surface 100 by means of a blind structure, or (3) by selectively replacing the surface sheet for covering the surface of each projection surface 100 by means of a roll structure.

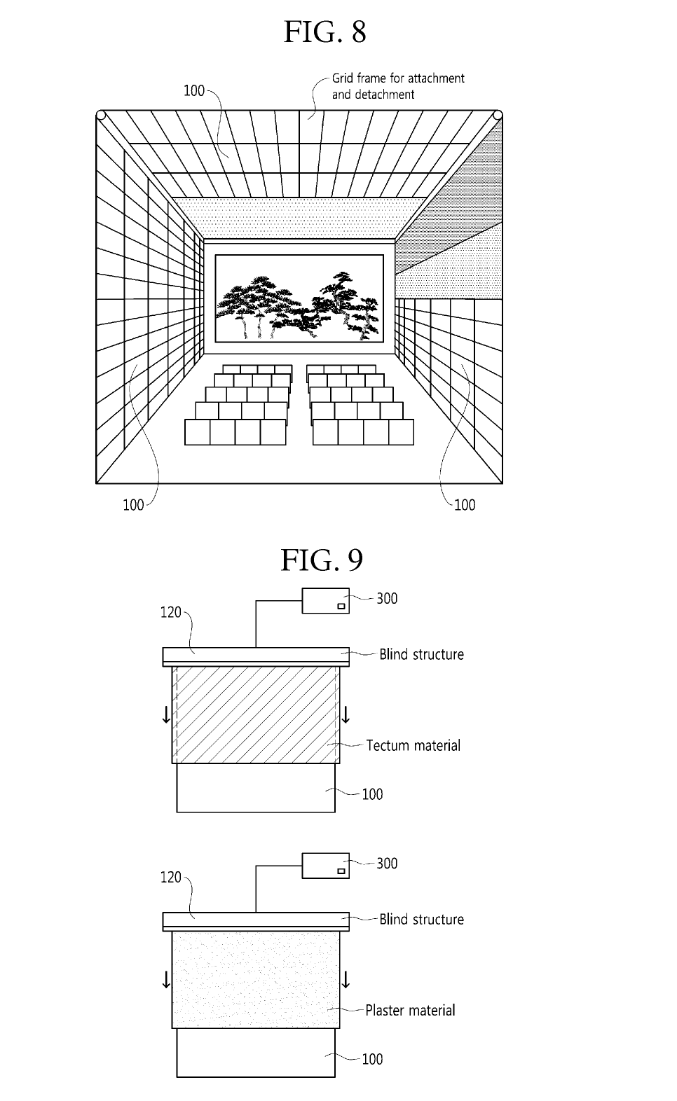

Referring to FIG. 8, the various surface materials of the plurality of projection surfaces 100 may be implemented by means of a detachable structure. Specifically, the various surface materials of the plurality of projection surfaces 100 may be implemented by means of a structure in which panels of various materials (e.g., fabric, plaster, tectum, curtain, aluminum, PVC, etc.) are detachably attached to a grid frame that is a skeletal frame. Meanwhile, the structure in which the panels of various materials are detachably attached to the grid frame may be implemented in various ways, such as by means of a detachable block structure, a fastening structure such as Velcro, etc.

Moreover, referring to FIG. 9, the various surface materials of the plurality of projection surfaces 100 may be implemented by a surface replacement device 120 including a blind structure. Here, the surface replacement device 120 may comprise sheets of various materials (e.g., a sheet made of fabric, a sheet made of tectum, a sheet made of plaster, a sheet made of PVC, a sheet made of aluminum, etc.), which are configured independently, and may construct an independent blind structure for each sheet (i.e., a structure of a plurality of blinds for a plurality of sheets). As a result, the surface of the projection surface 100 can be covered with the sheets of various materials by the structure of the plurality of blinds.

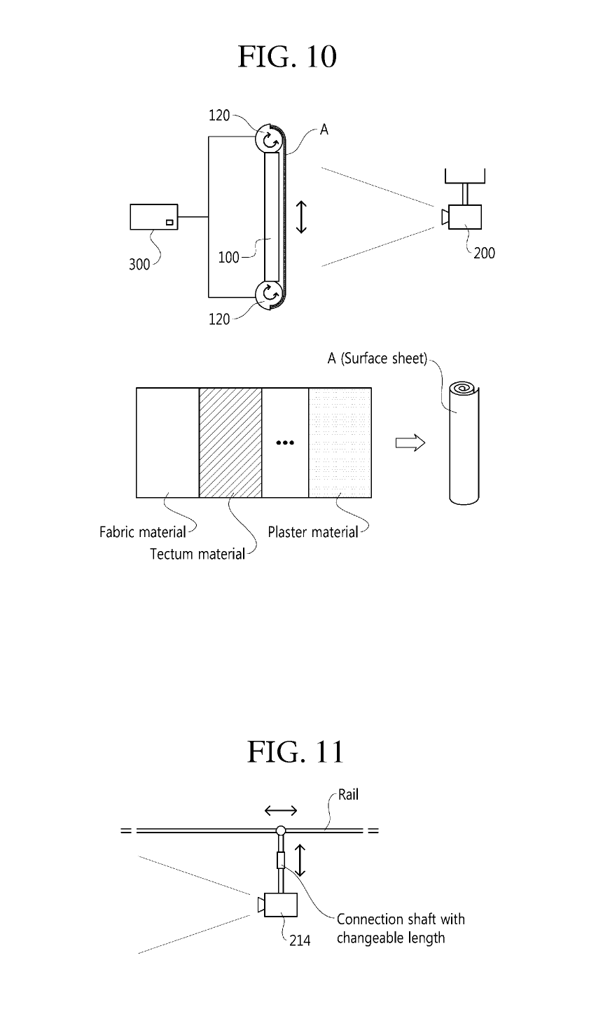

Furthermore, referring to FIG. 10, the various surface materials of the plurality of projection surfaces 100 may be implemented by a surface replacement device 120 including a roll structure. Here, the surface replacement device 120 may comprise a surface sheet in the form of a roll which can sequentially implement various materials such as fabric, tectum, plaster, PVC, aluminum, etc. and may selectively change the surface materials of the projection surface 100 by means of the surface sheet in the form of a roll. For example, the surface replacement device 120 may wind or unwind the surface sheet in the form of a roll using rotation devices installed on both sides of the projection surface 100 as shown in FIG. 9, and the surface of the projection surface 100 can be covered with the sheets of various materials by means of this operation.

The projection device 200 is configured to project synchronized images on the plurality of projection surfaces 100 and may be configured to move.

The projection device 200 may be configured as a single device comprising a plurality of projection units, but may preferably be two or more in number.

Moreover, the two or more projection devices 200 may be configured to move horizontally or vertically and thus may change their positions to various places in a three-dimensional space. Referring to FIG. 11, each of the two or more projection devices 200 may be configured to move along a rail installed on the ceiling, and a shaft connecting the rail and the projection device 200 may be configured to adjust its length. Therefore, the projection device 200 can freely move horizontally by the movement along the rail and can also freely move vertically by the adjustment of the length of the connection shaft. Meanwhile, the horizontal or vertical movement of the projection devices 200 may also be implemented by various other structures.

Furthermore, the two or more projection devices 200 may be configured to adjust their projection angle. Specifically, the two or more projection devices 200 may be configured such that the projection angle or direction of the projected image can be freely changed in a three-dimensional space. The adjustment of the projection angle of the projection device 200 may be implemented in various ways. For example, the projection angle of the projection device 200 may be changed by configuring a lens installed in the projection device 200 to move. Moreover, even when the lens itself of the projection device 200 is installed in a fixed manner, the projection angle can be changed by moving the entire body of the projection device 200. Referring to FIG. 11, a joint structure (e.g., a universal joint connection, ball joint connection, etc.) may be formed in the connection shaft of the projection device 200 such that the projection device 200 can perform a rotational movement, tilting movement, etc. by means of the joint structure, thus adjusting the projection angle of the projection device 200.

In addition, the two or more projection devices 200 may be configured to change the brightness or resolution of the projected image. For example, the two or more projection devices 200 may be configured to change (1) the brightness of the projected image by means of a lamp capable of adjusting light intensity or (2) the resolution of the projected image by autonomously adjusting the number or size of pixels of the projected image. Therefore, it is possible to selectively implement projection devices having various functions by means of this configuration.

Meanwhile, the two or more projection devices 200 may be connected to the simulation management device 300 through a wired or wireless network to be controlled by the simulation management device 300 and to receive images to be projected from the simulation management device 300.

Moreover, it is preferable that the two or more projection devices 200 is connected in parallel to the simulation management device 300, and the two or more projection devices 200 can be controlled individually or simultaneously by the parallel connection.

The simulation management device 300 is configured to control various devices (e.g., the driving device 110, the surface replacement device 120, the projection devices 200, etc.) included in the simulation system and to manage and process various data for the operation of the simulation system.

The simulation management device 300 may be implemented with various electronic devices. The simulation management device 300 may be implemented with a single electronic device or with several electronic devices interconnected to each other. For example, the simulation management device 300 may be implemented in a single server or in such a manner that two or more servers are interconnected. Moreover, the simulation management device 300 may be implemented in such a manner that a server and other electronic devices are interconnected or implemented in arithmetic units other than the server.

Moreover, the simulation management device 300 may further comprise a database storing system construction information (e.g., information on the number of a plurality of projection surfaces, arrangement information of the plurality of projection surfaces, surface information of the plurality of projection surfaces, arrangement information a the projection device, performance information of the projection device, etc.) of various multi-projection theaters (e.g., multi-projection theater A, multi-projection theater B, etc.) and may selectively implement the internal structures of various theaters based on the information stored in the database. For example, when the internal structure of multi-projection theater A is to be selectively implemented, the simulation management device 300 may use the system construction information of multi-projection theater A (e.g., information on the number of a plurality of projection surfaces, arrangement information of the plurality of projection surfaces, surface information of the plurality of projection surfaces, arrangement information of a projection device, performance information of the projection device, etc.) stored in the database and may implement the internal structure of multi-projection theater A by controlling the driving device 110, the surface replacement device 120, or the projection device 200 based on the information stored in the database.

Meanwhile, the simulation management device 300 may manage image content projected by the two or more projection devices 200. Specifically, the simulation management device 300 may prepare the image content to be projected by the two or more projection devices 200 from an internal database or through a communication network and provide the prepared image content to each projection device 200.

Moreover, when the internal structure of a specific multi-projection theater (e.g., multi-projection theater A) has been selectively implemented, the simulation management device 300 may correct the image content with reference to the system construction information of the specific multi-projection theater (especially, surface property information of the plurality of projection surfaces, performance information of the two or more projection devices, etc.) and may transmit the corrected image content to the two or more projection devices 200. In this case, (1) when the plurality of projection surfaces 100 comprise different types of surfaces, it is preferable that the simulation management device 300 corrects the images so as to offset differences in properties (e.g., brightness, color, image quality, material, structure, etc.) of the plurality of projection surfaces 100, and (2) when the two or more projection devices 200 are of different types, it is preferable that the simulation management device 300 corrects the images so as to offset differences in performance (e.g., lamp output, resolution, etc.) of the two or more projection devices 200.

Therefore, since the simulation is performed using the image content in a state where the image correction is completed, the simulation management device 300 allows problems, which cannot be solved by the image correction (e.g., the problem of heterogeneity that still occurs between the projection surfaces even after the image correction), to be diagnosed and analyzed.

For reference, the correction of the image content performed by the simulation management device 300 based on the information on the plurality of projection surfaces installed in the specific multi-projection theater will now be described. The simulation management device 300 may correct specific image content based on the information on the properties of the plurality of projection surfaces installed in the specific multi-projection theater. Specifically, the simulation management device 300 may correct the specific image content so as to offset the differences in properties based on the information on the differences in properties (such as a difference in color, a difference in brightness, a difference in reflectivity, a difference in material, a difference in structure, etc.) between the projection surfaces.

Representatively, the correction based on the information on the difference in color between the projection surfaces will now be described (the process which will be described below can, of course, be applied to the correction based on the difference in brightness, difference in reflectivity, difference in material, difference in structure, etc.). First, the simulation management device 300 may calculate information on a difference in chromaticity between the projection surfaces based on chromaticity information of the respective projection surfaces. In detail, the simulation management device 300 may set a single reference projection surface and then calculate information on a relative difference in chromaticity of each projection surface. For example, the information on the relative difference in chromaticity is calculated in such a manner that “projection surface A has a red (R) color level 50 higher than that of the reference projection surface, a green (G) color level 40 higher than that of the reference projection surface, and a blue (B) color level the same as that of the reference projection surface”. After the information on the difference in chromaticity of the respective projection surfaces is calculated in this manner, the images may be corrected based on the calculated information in such a manner so as to “reduce the R color level of the image projected on projection surface A by 50, reduce the G color level by 40, and maintain the B color level”, for example. Therefore, the difference in chromaticity of the projection surfaces can be offset.

Meanwhile, the analysis of the differences in properties of the plurality of projection surfaces may be performed in various ways other than the method of setting the reference projection surface. For example, it is possible to calculate representative values (e.g., mean values, median values, mode values, etc.) for the properties of the plurality of projection surfaces and then analyze the relative difference in properties based on the calculated representative values.

Moreover, the correction of the specific image content performed by the simulation management device 300 based on the information on the two or more projection devices installed in the specific multi-projection theater will now be described. The simulation management device 300 may correct the specific image content based on the information on the properties of the projection devices installed in the specific multi-projection theater. Specifically, the simulation management device 300 may correct the specific image content so as to offset the differences in performance based on the information on the differences in performance (e.g., a difference in brightness, difference in resolution, difference in image quality due to physical distance, etc.) between the two or more projection devices.

Representatively, the correction based on the information on the difference in brightness between the two or more projection devices will now be described (the process which will be described below can, of course, be applied to the correction based on the difference in resolution, difference in image quality etc.). First, the simulation management device 300 may offset the difference in brightness between the projection devices by correction. For example, if it is assumed that the brightness of projection device A is 500 ANSI Lumens, the brightness of projection device B is 1000 ANSI Lumens, and the brightness of projection device C is 1500 ANSI Lumens, this difference in brightness may be offset by the image correction. In detail, the brightness ratio of the images projected by projection devices A, B, and C is corrected to 3:2:1, thus offsetting the heterogeneity of the images which may occur due to the difference in brightness between the devices.

Meanwhile, a simulation system in accordance with another embodiment of the present invention may further comprise an additional effect device for implementing an additional effect other than the image.

mentioned above, the additional effect device refers to a device that adds a visual effect or an effect that can be perceived by other senses than sight so as to increase the immersion and reality that the audience can feel while watching the images. The additional effects that can be provided by the additional effect device may include a sound effect, a wind effect, a smell effect, a fog effect, a temperature change effect, a laser effect, a light effect, a bubble effect, a water jet effect, etc. as well as various effects associated with the five senses of human. Therefore, the additional effect device may comprise various devices such as a speaker, an air blower, a fragrance diffuser, a fog machine, a light-emitting device, a heater, a cooler, a laser device, a bubble generator, an LED, a water jet, etc. which can stimulate the five senses of human.

It is preferable that the additional effect device is two or more in number and is configured to move.

Moreover, it is preferable that the additional effect device is configured to move horizontally or vertically, like the projection device. Therefore, the additional effect device may also have various structures that can move horizontally or vertically. For example, the additional effect device may be configured to move horizontally by means of a rail structure and to move vertically by a change in length of a connection shaft (e.g., a frame for connection to the rail structure).

Moreover, the additional effect device may be configured to change the direction of the additional effect in various ways. For example, the additional effect device may be configured to perform a rotational movement, tilting movement, etc. by forming a joint structure (e.g., a universal joint connection, ball joint connection, etc.) in the connection shaft.

For reference, the movement of the additional effect device on the rail, the change in the length of the connection shaft, the movement of the joint connection structure etc. may be performed by means of various actuators, and the operation of the actuators may preferably be controlled by the simulation management device 300 (of course, the operation of the actuators may be controlled individually by a control unit and an input unit, which are included in the additional effect device).

Meanwhile, the additional effect device may be arranged on the surface of the plurality of projection surfaces (so as to reflect even a detailed structure of a specific multi-projection theater in the simulation, because when any one of the plurality of projection surfaces is configured with a wall in an actual multi-projection theater, an additional effect device such as a speaker, etc. may be installed on the surface of the wall).

The arrangement of the additional effect device on the surface may be implemented by the above-described vertical or horizontal movement, but may also be implemented by configuring the projection surface and the surface of the additional effect device to be attached and detached. In this case, it is preferable that the additional effect device has an independent structure that is separated from the rail or the connection shaft and is configured to be detachably attached to various positions of the projection surface by various fastening means (e.g., a detachable block structure, a fastening structure such as Velcro, etc.).

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A simulation system comprising a plurality of projection surfaces, each having a transformable structure,
wherein the simulation system selectively implements internal structures of various multi-projection theaters.

2. The simulation system of claim 1, further comprising a driving device for changing the structure of the projection surface,
wherein the driving device changes the size or arrangement of the projection surface.

3. The simulation system of claim 2, wherein the projection surface is configured to move by means of a rail structure.

4. The simulation system of claim 2, wherein the driving device is configured to adjust the arrangement angle of the projection surface by means of a joint structure.

5. The simulation system of claim 2, further comprising a surface replacement device which changes the surface material of the projection surface by replacing a surface sheet for covering the surface of the projection surface.

6. The simulation system of claim 5, wherein the surface sheet of the projection surface is changed by means of a roll structure or a blind structure.

7. The simulation system of claim 2, wherein the surface of the projection surface is configured to be attached and detached and the material of the projection surface is changed by the attachment and detachment of the surface.

8. The simulation system of claim 1, further comprising a projection device for projecting synchronized images on the plurality of projection surfaces.

9. The simulation system of claim 8, wherein the projection device is two or more in number and the two or more projection devices are configured to move horizontally or vertically.

10. The simulation system of claim 8, wherein the projection device is configured to move horizontally by means of a rail structure and move vertically by a change in length of a connection shaft.

11. The simulation system of claim 8, wherein the projection angle of the projection device is configured to be adjusted.

12. The simulation system of claim 11, wherein the projection angle of the projection device is adjusted by movement of a lens installed in the projection device.

13. The simulation system of claim 11, wherein the projection angle of the projection device is adjusted by means of a joint structure of the connection shaft.

14. The simulation system of claim 8, wherein the projection device projects a corrected image and the correction of the image is performed based on surface information of the plurality of projection surfaces after being transformed.

15. The simulation system of claim 14, wherein the correction of the image is performed so as to offset a difference in brightness, a difference in color, or a difference in reflectance between the transformed projection surfaces.

16. The simulation system of claim 1, further comprising an additional effect device for implementing an additional effect other than the image.

17. The simulation system of claim 16, wherein the additional effect device is configured to move horizontally or vertically.

18. The simulation system of claim 17, wherein the additional effect device is configured to move horizontally by means of a rail structure and move vertically by a change in length of a connection shaft.

19. The simulation system of claim 16, wherein the additional effect device is arranged on the surface of the projection surface.
